(19) United States
(12) Patent Application Publication
(10) Pub. No.: US 2014/0336954 A1
(43) Pub. Date: Nov. 13, 2014

(54) Calculating Fatigue and Fatigue Failure of Structures

(71) Applicants: Michael Bruyneel, Boncelles (BE); Stijn Donders, Kessel-Lo (BE); Michael Hack, Hessheim (DE); Christophe Liefooghe, Hove (BE); Peter Nuhn, Otterberg (DE); Stefan Strässer, Kaiserslautern (DE)

(72) Inventors: Michael Bruyneel, Boncelles (BE); Stijn Donders, Kessel-Lo (BE); Michael Hack, Hessheim (DE); Christophe Liefooghe, Hove (BE); Peter Nuhn, Otterberg (DE); Stefan Strässer, Kaiserslautern (DE)

(21) Appl. No.: 14/273,781

(22) Filed: May 9, 2014

(30) Foreign Application Priority Data
May 13, 2013 (EP) 13167410

(51) Int. Cl. G01L 5/00

(52) U.S. Cl. CPC G01L 5/00
USPC 702/34

(57) ABSTRACT

The durability performance of a structure is virtually predicted, enabling the optimization of the durability performance. In a first act, the structure is modeled by a series of calculation points. Then, for each point, the stresses and strains brought by load cycles and defining hysteresis branches are determined. Then, an accumulated damage due to the load cycles is predicted and stored. For the prediction, first, using a hysteresis operator, a change in the stress along a portion of a hysteresis branch is calculated as a function of a change in the load in time, and, second, using the change in the stress and the stored accumulated damage, a change in the damage is calculated. Hence, also a change in the properties, including the stiffness, of the structure is calculated. Then, a further change in the stresses and strains is calculated on the basis of the change in these properties to determine a new adapted hysteresis branch. Then, a further change in the stress along a further portion of the adapted hysteresis branch is calculated as a function of a further change in the load in time. At the end of the process, the structure is manufactured accordingly.

### TECHNICAL FIELD

The present embodiments relate to the field of predicting durability performance and fatigue behaviour of structures.

### BACKGROUND

Manufacturers in the transportation, wind energy and machinery sector are increasingly using lightweight materials, since the light weight materials allow delivering products with superior mechanical properties with a lower ecological foot print. Especially in transportation (automotive, aerospace . . . ), the substantial deployment of lightweight design materials, such as composites, will be a viable path to meeting the ever more stringent CO2 emission norms. At present, the massive deployment of lightweight materials in the industrial design and development process is however limited by the lack of predictive modeling tools to predict the macro-level behavior of lightweight materials structures. If better mechanical predictions can be made based on virtual models, the product can be optimized based on virtual simulations, rather than on late and expensive physical testing.

Composite materials can typically withstand many load cycles (i.e., have a good fatigue behavior). But the first damaging events that even change the stiffness of the component occur quite early and also at quite small load cycles. For product design engineers, this means that the engineers cannot design the product with a requirement that ‘no fatigue damage should occur at all’, since that would lead to typical overdesign of the structure. Instead, the engineer would like to be able to predict the fatigue behavior over the full lifetime—including the changes in stiffness, and the cross influences of the different damage mechanisms. By using the better understanding of the fatigue behavior in the product design decision process, it will be possible to achieve better, lighter and more cost-efficient designs.

In automotive applications, for instance, the analysis and synthesis of fatigue loads have highly improved over the last decades. For the current cars made of metals, a mature virtual design optimization process is in place, which enables the car manufacturers to tailor their cars to be adequate for the actual usage, and to align them with the requirements of different markets, while ensuring to avoid overdesign. This involves complex load schedules for different roads with fully variable loading. In contrast, for composites materials, no mature tools are in place to virtually predict the product performance. This means that expensive physical testing approaches in a rather late stage of the design process are needed to check/validate whether the composite material design meets the requirements.

The problem to be solved is to bring in place a new virtual process to predict the durability of composites structures and to include the new process in a numerical apparatus or toolset that can be used to predict and optimize the durability performance of mechanical structures. The availability of the innovative process and associated toolset will enable the industry to improve their design process for their lightweight products, achieving a better product quality at lower cost. Ingredients for such a successful methodology are: Ability to include the progressive damage in the models (i.e. the ability to predict the evolution of damage in the composites in time), and keep track of the actual damage state in the simulation models. Ability to predict the damage accumulation at each moment in time that takes the actual damage into account. The damage evolution towards the next step is to be predicted. This requires a so-called ‘hysteresis operator’ approach that predicts the increase in damage (dD/dN) in each point in the model. Ability to include the influence of variable cyclic loads. Such time-varying loads are what structures in operation (e.g. in automotive or aerospace structures or wind turbines) experience, so the structures are designed to withstand this. Variable amplitude loads are often replaced by simplified signals as block loads as the block loads simplify the simulation and the test set up. But if only block loads (i.e., constant loading over time) are used in the design process, this is not sufficient to ensure that the structure can withstand realistic loads during its lifetime. Moreover, in these cases, large safety factors are added to the design. The addition contradicts the paradigm of light weight design. Therefore, the simulation of fatigue has to include also the influence of variable cyclic loads.

Finite Element (FE) Analysis (FEA) is a well-known numerical technique for modeling a mechanical structure. The model includes many small and simple ‘elements’. Each such element defines a very simple mechanical problem (e.g., a plate-like structure in which the mechanical equations are evaluated in a number of integration or calculation points). After building the numerical FEA model, one can establish a matrix equation of the complete structure, which contains the large list of simple ‘elements’ problems in relation to each other. Solving this equation allows approximating the mechanical behavior of the structure based on the solution of the many small elements problems. It is state of the art to base fatigue predictions on mechanical FE models. A typical result of a FEA is the mechanical prediction of the stresses and strains in the structure based on a FE model of the structure.

One technique that is already known from failure prediction for metal structures is using SN-curves and linear damage accumulation. An SN-curve represents the magnitude of a stress or load cycle applied to a material as a function of the amount of cycles before fatigue failure occurs (i.e., before the material breaks). The data to populate the SN-curves is typically obtained from testing (i.e., obtained from simple standardized samples of material (i.e., so-called “coupon testing”)). The SN-curves are derived for a selected load direction (e.g., longitudinal or transversal load). Using the rainflow counting approach, the complex load cycles can be split up in a set of simple load cycles with different amplitudes. Using these amplitudes, the number of cycles before failure can then be derived from the SN curves.

Predicting failure using SN-curves can thus handle variable amplitude loads, but cannot take into account multi-axiality. A further disadvantage is that the effect of progressive damage and, thus, the reduction of the stiffness and redistribution of stress in the structure cannot be taken into account. This means that rainflow based approaches can handle stress-strain behavior and damage accumulation only in the case that there is a fixed relationship between stress and strain, and that the same stress-strain cycles always induce the same damage.

Therefore, the use of SN-curves is very limited for composite structures. For variable amplitude loading, it is very typical that the largest load cycles—that contribute most to the damage—take a very long time to complete, due to the many nested cycles inside. In this case, the approach to only consider cycles when the cycles are completed, as in the rainflow approach, can no longer be justified.

Traditional fatigue damage accumulation uses rainflow counting and linear Miner-Palmgren damage accumulation. In the case of composites, one experiences that the fatigue behavior is changing over time due to several different damage mechanisms, because the damaging effects are connected to stress-strain hysteresis loops or branches. These loops are typically nested in each other, such that before one large loop closes there may be many small loops that open and close in between. So it is very typical that the largest load cycles—that contribute most to the damage—take a very long time to complete, due to the many nested cycles inside. In this case, the approach to only consider cycles when they are completed as in the rainflow approach can no longer be justified.

In “Brokate, M; Dressler, K; Krejci, P: Rainflow counting and energy dissipation in elastoplasticity, Eur. J. Mech. A/Solids 15, 705-737 (1996)” a method was developed for damage accumulation that can take into account changes in the fatigue and material behavior due to external changes (e.g., temperature). This approach uses two hysteresis operators—one for the stress-strain behavior and one for the damage behavior. Using these operators with fixed stress-strain behavior, and damage evaluation based on SN-curves leads to the same behavior as the rainflow and SN curve based approaches mentioned before.

In “Nagode, M. & Hack, M., The damage operator approach, creep fatigue and visco-plastic modelling in thermo-mechanical fatigue, SAE International Journal of Materials & Manufacturing, 4(1), 632-637. doi:10.4271/2011-01-0485, (2011)” this approach was extended to the case that the stress-strain behavior and the damage behavior depend on external functions (e.g., temperature), which change both the stress-strain behavior and the damage behavior. Even though the extension enables the inclusion of external parameters, the extension still is not able to include a behavior like for composites where the stress-stain behavior and damage also depends on the damage that is accumulated up to a certain point.

In the prior art publication “Van Paepegem, W.; Development and finite element implementation of a damage model for fatigue of fiber reinforced polymers, Ph.D. thesis, Department of Material Science and Engineering, Ghent university, 2002.” a methodology for the simulation of progressive damage and thus composite fatigue simulation is disclosed using the N-Jump algorithm. There, the damage accumulation and stress redistribution is calculated using a full finite element analysis at deliberately chosen intervals. The degradation of stiffness in the material is calculated and further extrapolated at corresponding cycles. The disadvantage of this methodology is that the methodology is only applicable for block loading and thus, cannot be used for variable amplitude loading.

### SUMMARY

The scope of the present invention is defined solely by the appended claims and is not affected to any degree by the statements within this summary.

The present embodiments are not restricted solely to composite structures, as the embodiments are also applicable to structures made of other materials. Therefore, the embodiments also apply to elastomer materials or any other material that has the property that damage accumulates in the material due to load cycles before the structure fails due to fatigue failure.

Due to the fact that a hysteresis operator is used and time steps in between the full amplitude of the load cycles are taken into account, nested loop cycles and multiple load cycles with variable amplitudes can be taken into account.

Due to the fact that the change in material properties is taken into account, fatigue failure for long load cycles can be predicted. These long load cycles, for example, do not represent a short distance on a virtual durability test track simulation, but may represent thousands of kilometres on a virtual test track simulation. Therefore, the prediction may be more accurate and corresponds to a real life case.

Due to the fact that the accumulated damage and, hence the change in material properties, are taken into account, the local redistribution of stress is accurately simulated and, hence, the prediction of the fatigue failure is more accurate.

Due to the more accurate simulation of the fatigue, less overdesign of the composite structure is needed. This results in a lighter structure for a given set of durability and performance requirements of the structure.

According to an embodiment of the first aspect, a process further comprises updating the model of the composite structure to an updated model with the change in properties and, for each calculation point, new stresses and strains brought by the load cycles and defining hysteresis loops are determined.

Due to the fact that the model of the composite structure is updated and the stresses and strains in the calculation points are recalculated, the global redistribution of the stress, and, thus, the reduction or increase in stiffness throughout the composite structure is taken into account.

### BRIEF DESCRIPTION OF THE DRAWINGS

The embodiments shall be better understood in light of the following description and of the accompanying drawings were

FIG. 1 illustrates a preferred embodiment of a process;

FIG. 2 illustrates a beam attached to a wall as an example of a composite structure submitted to external forces or loads;

FIG. 3 illustrates an example variation of a load as a function of time;

FIG. 4 illustrates an example hysteresis loop with a nested loop cycle;

FIG. 5 illustrates an example relative stiffness of a composite material as a function of the relative load cycle;

FIG. 6 illustrates an example change in a hysteresis curve;

FIG. 7 illustrates a further embodiment of a process; and

FIG. 8 illustrates an embodiment of a system.

### DESCRIPTION OF ILLUSTRATIVE EMBODIMENTS

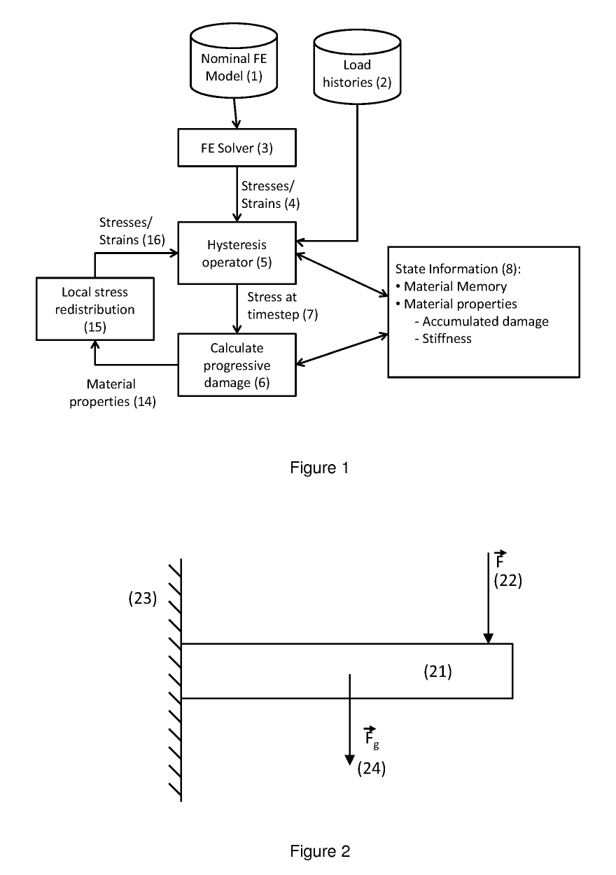

FIG. 1 illustrates the several acts of the process according to a preferred embodiment. By this process, the durability performance of a composite structure can be predicted. In other words, how many load cycles this composite structure would be able to withstand before the structure fails due to a fatigue failure can be predicted.

In a first act (1), a model of the composite structure of which the durability performance will be predicted is obtained. In this first act, the structure is modeled by a series of elements including one or more calculation points. This may be a Finite Element (FE) model. As well known in the art, such a model divides the structure into a series of simple elements and the interaction between every element of the structure is described by a simple equation whereas, when the structure as a whole would be considered, a set of complex partial differential equations would have to be solved. Such a model typically includes the geometrical properties of the structure and how the structure is divided into a series of these simple elements. Next to this, the model also includes how external forces act on the structure and further includes the material properties of the structure such as, for example, the stiffness of the structure. In FIG. 1, this model is denoted as a Nominal FE model to indicate that the model is the initial model used in the beginning of the process.

An illustrative example of such a structure is shown in FIG. 2, where a beam structure (21) is attached to a wall (23). Next to the forces that keep the beam attached to the wall, the beam is further submitted to an external force F (22) and the force Fg (24) caused by gravity. The external force (22) could, for example, be caused by a weight or torsion induced by another structure that is attached to the beam. As a model, a CAD drawing of the beam may be provided together with an indication of where and in which direction all these forces apply. On the basis of this CAD drawing, the beam is then further divided in a series of elements comprising calculation points and a matrix equation defining the interaction between the elements is constructed.

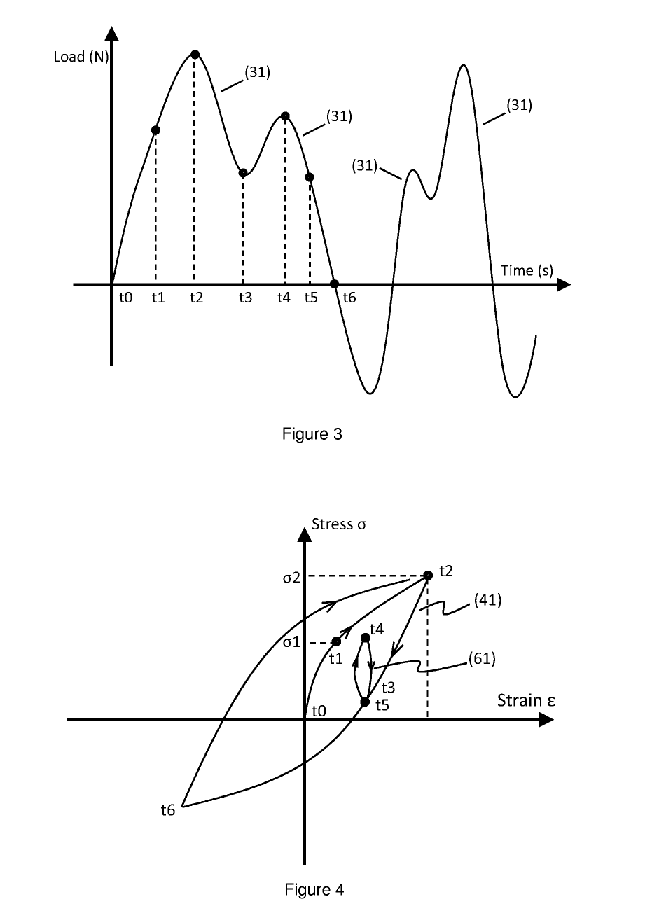

Fatigue failure in a composite structure will occur when the structure is submitted to a series of load cycles (i.e., external force(s)) that vary in amplitude over time. In order to predict the durability performance, the process also has these load cycles as an input. In FIG. 1, this is denoted as the Load histories (2). FIG. 3 illustrates how such a load (y-axis) may vary in time (x-axis) by different load cycles (31). This variation of the load, typically forces or moments specified in Newton, respectively, Newtonmeters or equivalent units, may not be repetitive nor have a fixed amplitude. Returning to the example of FIG. 2, the load cycles of FIG. 3 would then represent how the external force (22) acts on the beam structure. A structure may be submitted to different loads having different load cycles. The load cycles will typically correspond to a real life case in which the structure will be used and may be obtained either from simulation or from measurements. For example, when the structure would be the axle of a car, the load cycles will correspond to forces caused by bumps in the road, by taking corners, by braking, etc. . . . The load histories can then be constructed by simulating such situations or by actually measuring the external forces acting on an axle of a car during such situations. In a next act (3) of the process, the stresses and strains (4) brought by the load cycles (2) are determined. Due to the forces induced by the load cycles and in the model of the structure, stress will build up along the structure. Stress is well known to express the internal forces that neighbouring elements or particles of a continuous material exert on each other. Stress is typically expressed in Megapascals (MPa) or Newtons per square millimetre (N/mm²). The calculation of these stresses and strains may be done using a Finite Element (FE) Solver (3) that performs a Finite Element Analysis (FEA) taking as input the Nominal FE model (1). The FE Solver thus also takes as input how external forces act on the structure and the material properties as also defined by the FE model (1). As a result, the FE solver calculates the displacements at the so-called nodes. From the displacements, the FE sovler calculates the related stresses (denoted by a) and strains (denoted by E) values in every element. These stresses may be calculated for a number of calculation points in the element. For composite structures, this is typically done also at the different plies. In all the calculation points where the stresses and strains are calculated, the fatigue analysis may be performed. The strain indicates the displacement of an element of the structure caused by the stress. As strain is a relative measure, the strain is defined by the ratio between the local displacement and the global displacement.

In the example of FIG. 2, under the forces F and Fg, stresses would build up along the beam and cause the beam to bend downwards. With the calculation of the stresses and strains by the FE solver, one can know how every part of the beam would bend and how bending would relate to the internal stresses built up in the beam. The smaller the elements of the model are chosen, the more precise the calculation of the stresses and strains will be, but also the more time it will take to perform the calculation.

The process then proceeds to acts (5) and (6), where an accumulated damage due to the load cycles (2) is predicted and stored (8). These acts will now be explained in more detail.

Act (3) will relate the stresses and strains to the external forces or loads, but only for a static case (i.e., only for non-varying external forces (22)). However, to predict the fatigue of the composite structure, the process also accounts for the complex variation of the load in time defined by the Load Histories (2). When a structure is submitted to such load cycles, the relation between the stresses and the strains (4) obtained from the FE Solver in every calculation point of the structure exhibit a memory effect. In other words, the strain is not only dependent on the material but also on the history of the stress (i.e., how the path to the stress was established). This is illustrated in FIG. 4 where the variation of the stress and strains in a calculation point of the composite structure is shown and how the stress and strain evolve from an initial time t0 up to time t6. The timestamps t0-t6 of FIG. 3 corresponds to the timestamps t0-t6 of FIG. 4. The path t0-t6 in FIG. 4 thus shows how the stresses σ and strains ε in a calculation point of the composite structure evolve under the influence of the varying load (i.e., the load cycles of FIG. 3). The load cycles of FIG. 3 follow a hysteresis curve, loop or branch (41)(42) in the representation of FIG. 4. As the cyclic variation of the load in time is complex, the hysteresis curves or loops will be nested. In other words, a new loop (42) (e.g., t3-t4-t5) starts before another loop (41) has ended (e.g., t2-t6). Therefore, the stresses and strains (4) brought by the load cycles (2) are defining hysteresis loops (42) (41).

In act (5), using a hysteresis operator (5), a change in the stress (7) along a portion of the hysteresis loop is now calculated as a function of a change in the load in time. Based on the load histories (2) and the output of the FE Solver (3), a hysteresis operator calculates the stress al (7) (see FIG. 4) related to a next time step t1 (see FIGS. 3 and 4). A possible implementation of a hysteresis operator may be found in “Nagode, M. & Hack, M., The damage operator approach, creep fatigue and visco-plastic modelling in thermo-mechanical fatigue, SAE International Journal of Materials & Manufacturing, 4(1), 632-637. doi:10.4271/2011-01-0485, (2011)”. Thus, a change in the stress along a portion of the hysteresis loop is calculated as a function of a change in the load in time. Due to the hysteresis effect in the composite structure, the hysteresis operator not only takes into account where the operator is inside a single loop, but also whether the loop is already nested inside another loop. In order to do so, the hysteresis operator (5) keeps track of the memory of the material. In the act (5), internal state variables (8) also keep track of where exactly along the hysteresis curve the process is at every execution of act (5) of the process. The state information is thus keeping track of the material memory. In other words, the hysteresis operator (5) includes storing information of the position in the hysteresis loop (41) as state information (8).

Referring to the example of the beam in FIG. 2, the hysteresis operator (5) calculates the stress in each calculation point of the beam for a certain value of the applied force F (22) at a certain time t1. When the Force applied to the beam would start at zero (no force applied), then go to a maximum at time t3 and return to zero at time t6 (again no force applied), the residual strain will not return to zero and, thus, the beam remains bended to a certain degree even when no force is applied. This illustrates the memory effect in the material of the beam.

In a further act (6), using the change in the stress (7) from act (5) and the stored accumulated damage, a change in the damage is calculated (6), and, hence, a change in the properties (14), including the stiffness, of the structure in each calculation point is also calculated. As the process is an iterative process, when executing act (6) for the first time, the value of the accumulated damage has an initial predetermined value, zero for example. In a composite structure, every load cycle (31) produces a change in damage inside the structure. After a certain amount of cycles, the total sum of all the changes in damage (i.e., the accumulated damage), exceeds a certain threshold and fatigue failure occurs. In composite structures, the change in damage or progressive damage may be characterized as follows:

$$\frac{\partial {d}_{l}}{\partial N} = f ( {d}_{l} , σ ( {d}_{l} ) , T … ) \qquad [ eq 1 ]$$

In other words, the change in damage

$$\frac{\partial {d}_{l}}{\partial {N}_{-}}$$

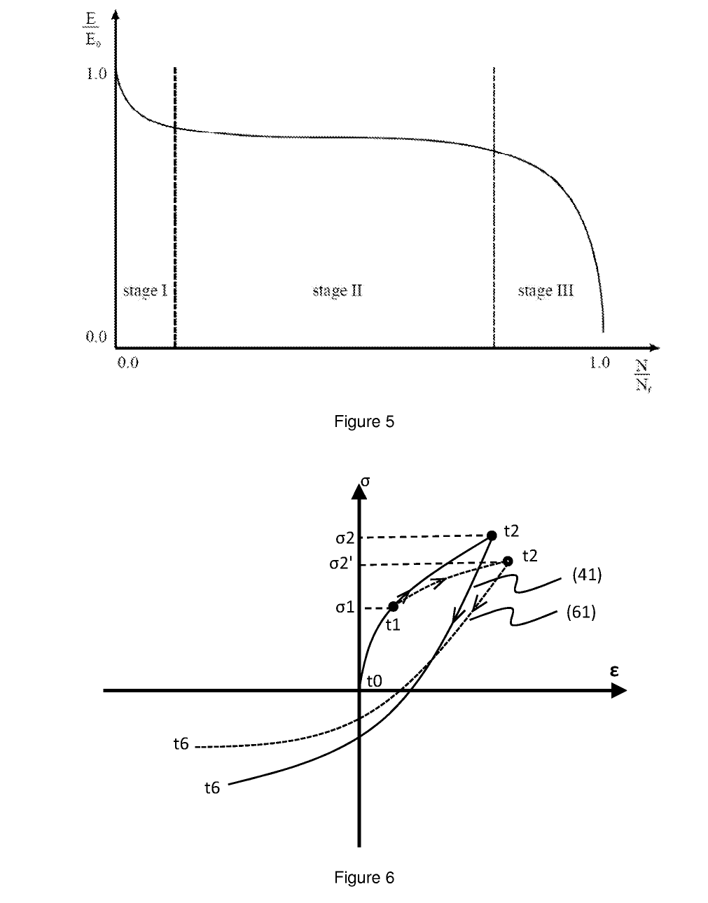

in a certain direction I of the material caused by a certain load cycle (N) of the load cycles depends on the already total accumulated damage (dₗ) and the stress a induced by the load cycle. The stress on its turn also depends on the already accumulated damage dₗ. This is illustrated by FIG. 5 where the change in relative stiffness (E/E0) is plotted against the relative number of load cycles (N/Nf) for a predetermined stress value in a composite material. As apparent from FIG. 5, the change in stiffness depends on the load cycle. The stiffness on its turn may be further related to the accumulated damage by:

Eₗ=Eₗ⁰(1−dₗ) [eq 2]

whereby
E₁_{₀} is the stiffness of the material in a direction I,
Eₗ is the original stiffness before the loading, and
dₗ is the total accumulated damage.

The following equation related to the curve in FIG. 5 and the above relation between the damage and stiffness then results in the progressive damage as calculated in act 6:

$$\frac{\partial {d}_{l}}{\partial N} = {c}_{1} \cdot {\sum }_{l} \cdot {e}^{( - {c}_{2} \frac{{d}_{l}}{\sqrt{{\sum }_{l}}}} + {c}_{3} \cdot {d}_{l} \cdot {\sum }_{l}^{2} \cdot [ 1 + {e}^{( {c}_{5} \cdot ( {\sum }_{l} - {c}_{4}} ] \qquad [ eq 3 ]$$

whereby

$${\sum }_{I} = \frac{σ}{\frac{( I - {d}_{I}}{XI}}$$

is the relative stress value, and
Xₗ is the static strength constant that indicates at which stress static value the structure is permanently damaged, and c1, c2, c3, c4 and c5 are constants related to the material obtained by stress measurement of material samples, and dₗ is the total accumulated damage in a direction I of the structure.

The above equations are just an example on how to derive the change in damage and properties of the structure, but the embodiments are not limited thereto. In general, the calculation of the change in damage may directly use characterization data relating the change in damage and properties to the accumulated damage and to the change in the stress as illustrated by FIG. 5. Or, as shown by [eq 3], calculating the change in the damage may further include using an analytical formula for obtaining the change in the damage. The analytical formula is then an approximation of the characterization data.

The new value of the accumulated damage is then derived from the previous value of the accumulated damage and the progressive damage just obtained. This new value is then stored as state information (8) as part of the material properties until a next iteration of the process. Similarly, a new value of the stiffness Eₗ, which is a material property, is calculated.

Referring to the example of the beam of FIG. 2, in act (6) of the process for each calculation point of the beam, one could take the formula for the progressive damage and fill in the value of the obtained stress (7), the already accumulated damage from the state information, and the material constants and obtain a value for the change in damage. With this change in damage, the accumulated damage in the state information (8) is then updated to a new value. As the material stiffness has changed due to the accumulation of damage in the material, the hysteresis curve (41) as depicted in FIG. 4 is no longer up to date. The relation between the stresses and strains in each calculation point of the composite structure has changed and needs to be recalculated. Therefore, in a act (15), a further change in the stresses and strains (16) is calculated (15) on the basis of the change in the properties (14) to determine (7) new adapted hysteresis branches. Due to the continuous change in the stress-strain behavior, loops do not need to close anymore, therefore the loops can also be annotated as branches to indicate the fact that the loops do not close. In other words, the stresses and strains are locally redistributed in the calculation points of the model of the structure because of the change in the stiffness Eₗ. Physically speaking, the stiffness value Eₗ is a measure of the slope of the hysteresis curve. As in the recalculation of the stress, the interaction between the elements of the composite structure is not taken into account as the redistribution of the stress is said to be local. As illustrated in FIG. 6, this further change in the stresses and the strains (16) defines an adapted hysteresis branch (61).

Referring to the example of the beam of FIG. 2, updating the stresses and strains (16) would mean that the beam would bend more or less. This would even be the case when applying the same force, but in a different cycle of the load histories (2). For example, when the stiffness of the elements in the beam would decrease, the beam would bend more for the same applied force in a next load cycle.

After act (15), the process arrives back at act (5) where a further change in the stress (7) along a further portion of said adapted hysteresis branch is calculated (5) as a function of a further change in the load in time. Referring to FIG. 3 and FIG. 4, this means that a new value of the stress in a calculation point of the composite structure at a next time step t2 is calculated. This is illustrated in FIG. 6 where the new hysteresis curve (61) leads to a new stress value σ2′ at time step t2. If the curve would not have been updated with the new material stiffness value, another erroneous stress value σ2 would have been obtained. In order to be able to proceed along the hysteresis curve, at every act (5) when calculating the change in the stress (7) along a portion of the adapted hysteresis branch, the stored information about the material memory comprising the current position in the hysteresis curves is used. With the new stress value σ2′ at time step t2, the process then moves again to act (6) where the progressive damage and new value of the stiffness is obtained as described before. The iteration along acts (5), (6) and (15) then continues while continuously updating the state information (8) (i.e., the material memory (e.g., hysteresis branch position) and the change in properties of the material (e.g., stiffness and accumulated damage)). At a certain time tn in the load cycles (2), one of the calculation points in the composite structure will exceed a certain damage accumulation value (and thus related stiffness value) and, thus, fatigue failure occurs. At that moment, the durability performance of the composite structure is known because it is known at which time in the Load Histories (2) the fatigue failure occurs. At that time, the obtained fatigue property of the composite structure might be satisfactory and the structure may be manufactured with the material properties and dimensions as specified by the nominal FE model (1). If not satisfactory, the composite structure and, hence, the model can be adapted and the prediction of the durability performance is repeated. This way optimization of the durability performance of the composite structure can be obtained.

Referring to the example of the beam, when going through the iterative acts (5), (6) and (15), at a certain time tn in a certain calculation point of the beam, the damage accumulation would be as such that the stiffness is too low. In other words, the beam would bend too much according to the requirements or the beam would just break.

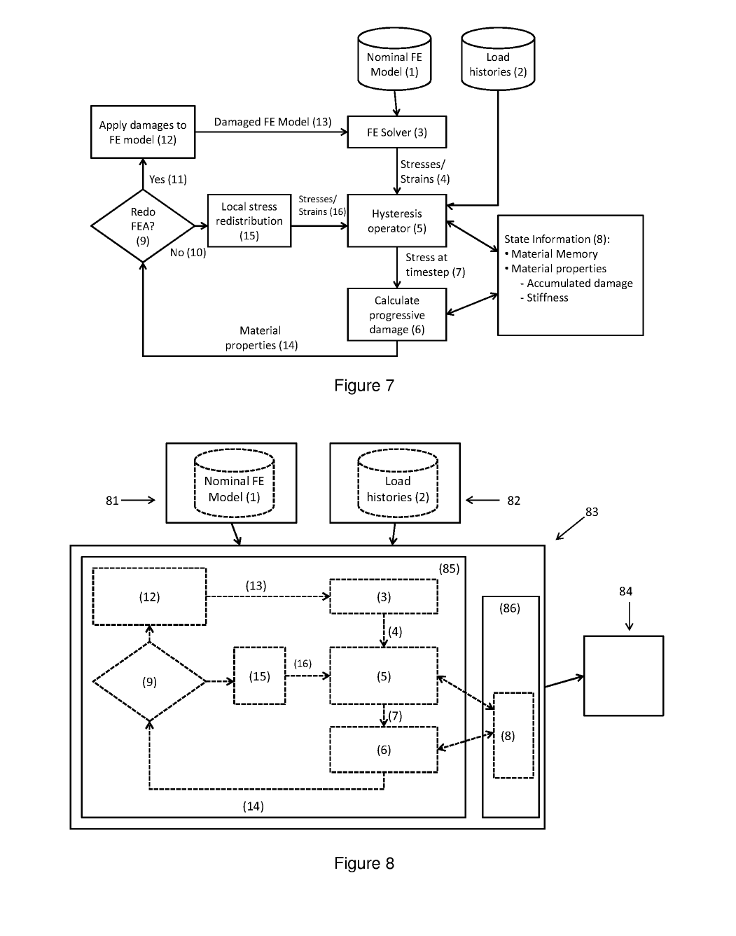

FIG. 7 illustrates further acts that improve the accuracy of the process. As pointed out before, the accumulation of damage leads to a local degradation of the stiffness in the elements of the composite structure. This also has the consequence that there will be a global redistribution of the stress in the composite structure. The global redistribution may only be accounted for by a new finite element calculation. Therefore, when performing a global redistribution of the stress, act (12) of updating the model of the structure with the change in properties to an updated model (13) is performed and, for each calculation point, new stresses and strains (4) brought by the load cycles (2) and defining hysteresis branches are determined. Before performing act (12), it is decided (9) whether to perform the updating (12) of the model of the structure or to perform (15) the calculation of the further change in the stresses and strains (16).

When it is decided to redo the FEA analysis, the state of the system is saved using the state information (8):
all local damage accumulation states are saved;
all internal states (material memory) of the hysteresis operator are saved; and
the time in the load history (2) is saved.

Then, the changes in the material properties, such as the stiffness, are applied to the finite element model (12) and, hence, a damaged FE model and, thus, an updated model (13) is obtained. Then, updated stresses and strains (4) are calculated by the FE Solver (3) and the hysteresis operator resumes where it had stopped.

According to a second aspect, an embodiment also relates to a system for performing the process described above. An embodiment of such a system is illustrated in FIG. 8.

The system includes a device (81) for modelling the composite structure by a series of simple elements including one or more calculation points. This may be done by a computer where a model of a composite structure is drawn using the input devices (mouse, keyboard, . . . ) of the computer. Using the computer, the model is then further finalized by defining the elements and thus the FE model, the external forces and material properties. Furthermore, the device (81) may also include a scanning device to digitize a physical prototype of the structure and a computer on which the FE model is further finalized.

The system further comprises a device (82) for determining the load histories (2) and, thus, load cycles. The afore-mentioned device may be another computer or the same computer as comprised in the device (81) for determining the load cycles by simulation. The device (82) may also include a test setup to measure the load cycles by an actual physical experiment.

The system may further include a computer (83) for performing the acts (3), (5), (6), (9), (12) and (15) of the process. These acts may be written in programming language as instructions stored in a non-transitory computer readable medium. The instructions are executed by a processor (85) of the computer (83). The computer (83) may further include storage (86) for keeping track of the state information (8). This storage could be the RAM memory or hard drive of the computing means (83).

The system further comprises a device (84) for manufacturing the composite structure accordingly.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A process for virtually predicting the durability performance of a structure, wherein the structure is modeled by a series of calculation points, the process comprising:
for each calculation point, determining the stresses and strains brought by load cycles and defining hysteresis branches;
predicting, by a processor, an accumulated damage due to the load cycles;
storing, in a memory, the accumulated damage;
using a hysteresis operator, calculating, by the processor, a change in the stress along a portion of a hysteresis branch as a function of a change in the load in time;
using the change in the stress and the stored accumulated damage, calculating, by the processor, a change in the damage, and, hence, a change in the properties, including the stiffness, of the structure at the calculation point;
calculating, by the processor, a further change in the stresses and strains on the basis of the change in the properties, providing a new adapted hysteresis branch; and
calculating, by the processor, a further change in the stress along a further portion of the adapted hysteresis branch as a function of a further change in the load in time, wherein the structure is made of material that accumulates damage before the structure fails due to fatigue failure when submitted to the load cycles.

2. The process according to claim 1 wherein determining the stresses and strains brought by load cycles further comprises performing a finite element analysis on a finite element model of said structure, said finite element analysis being performed based on external forces applied on said structure by said load cycles.

3. The process according to claim 1 further comprising updating the model of the structure with the change in properties to an updated model and, determining, for each calculation point, new stresses and strains brought by the load cycles, and defining hysteresis branches.

4. The process according to claim 3 further comprising, before the updating, deciding whether to perform the updating or to perform the calculating of the further change in the stresses and strains.

5. The process according to claim 1 wherein using the hysteresis operator further comprises storing information of the position in said hysteresis branch as state information, and wherein calculating the change in the stress along a portion of the adapted hysteresis branch uses the stored information.

6. The process according to claim 1 wherein calculating the change in the damage further comprises using characterization data relating the change in damage and properties to the accumulated damage and to the change in the stress.

7. The process according to claim 6 wherein calculating the change in the damage further comprises using an analytical formula for obtaining the change in the damage, the analytical formula being an approximation of the characterization data.

8. The processor according to claim 2 further comprising updating the model of the structure with the change in properties to an updated model and, determining, for each calculation point, new stresses and strains brought by the load cycles, and defining hysteresis branches.

9. The process according to claim 3 wherein using the hysteresis operator further comprises storing information of the position in said hysteresis branch as state information, and wherein calculating the change in the stress along a portion of the adapted hysteresis branch uses the stored information.

10. The process according to claim 5 wherein calculating the change in the damage further comprises using characterization data relating the change in damage and properties to the accumulated damage and to the change in the stress.

11. A system for virtually predicting the durability performance of a structure, said system comprising:
a memory storing instructions;
a processor configured, based on the instructions, to:
model the structure by a series of calculation points,
determine, for every calculation point, the stresses and strains brought by load cycles, the load cycles defining hysteresis branches,
determine the load cycles,
predict, for every calculation point, an accumulated damage due to the load cycles,
store, for every calculation point, the accumulated damage,
calculate, for every calculation point, a change in the stress along a portion of a hysteresis branch as a function of a change in the load in time using a hysteresis operator,
calculate, using the change in the stress and the stored accumulated damage, a change in the damage for every calculation point and, hence, for every calculation point, a change in the properties, including the stiffness, of the structure at the calculation point,
calculate, for every calculation point, a further change in the stresses and strains on the basis of the change in the properties, providing a new adapted hysteresis branch, and
calculate, for every calculation point, a change in the stress along a portion of said adapted hysteresis branch as a function of a further change in the load.

12. The system according to claim 11 wherein the processor being configured to determine the stresses and strains brought by load cycles further comprises for the processor being configured to perform a finite element analysis on a finite element model of the structure, the finite element analysis being performed based on external forces applied on the structure by said load cycles.

13. The system according to claim 12 wherein the processor is further configured to update the model of the structure with the change in properties and, for each calculation point, determine new stresses and strains brought by said load cycles and define hysteresis branches.

14. The system according to claim 11 wherein the processor is further configured to update the model of the structure with the change in properties and, for each calculation point, determine new stresses and strains brought by said load cycles and define hysteresis branches.

15. The system according to claim 11 wherein the material comprise a composite material or an elastomer material.

16. A non-transitory computer readable medium storing instructions executable by a processor, the instructions comprising:
for each calculation point, determining the stresses and strains brought by load cycles and defining hysteresis branches;
predicting, by a processor, an accumulated damage due to the load cycles;
storing, in a memory, the accumulated damage;
using a hysteresis operator, calculating, by the processor, a change in the stress along a portion of a hysteresis branch as a function of a change in the load in time; using the change in the stress and the stored accumulated damage, calculating, by the processor, a change in the damage, and, hence, a change in the properties, including the stiffness, of the structure at the calculation point;
calculating, by the processor, a further change in the stresses and strains on the basis of the change in the properties, providing a new adapted hysteresis branch; and
calculating, by the processor, a further change in the stress along a further portion of the adapted hysteresis branch as a function of a further change in the load in time, wherein the structure is made of material that accumulates damage before the structure fails due to fatigue failure when submitted to the load cycles.

17. The non-transitory computer readable storage medium of claim 16 further comprising instructions for updating the model of the structure with the change in properties to an updated model and, determining, for each calculation point, new stresses and strains brought by the load cycles, and defining hysteresis branches.
